(19) United States
(12) Patent Application Publication
(10) Pub. No.: US 2015/0363378 A1
(43) Pub. Date: Dec. 17, 2015

(54) MANAGING DOCUMENT UNIT REFERENCES TO IMPROVE COLLABORATIVE DOCUMENT EDITING

(71) Applicant: INTERNATIONAL BUSINESS MACHINES CORPORATION, Armonk, NY (US)

(72) Inventors: Blaine H. Dolph, Western Springs, IL (US); Ava Hakim, Chicago, IL (US); Steven M. Kagan, Burr Ridge, IL (US); Jennifer Martin, South Melbourne (AU)

(21) Appl. No.: 14/303,806

(22) Filed: Jun. 13, 2014

(51) Int. Cl. G06F 17/24; G06F 17/22; G06F 17/30; H04L 29/06

(52) U.S. Cl. CPC G06F 17/246; H04L 65/403; G06F 17/2288; G06F 17/30011

(57) ABSTRACT

An approach is provided for managing a display of document unit references. Units of an original version of a document and original references to the units are stored in nodes of a data structure. Responsive to an insertion of a new unit at a location in the document, a new node is inserted into the data structure at a corresponding location, or responsive to a deletion of a unit at the location in the document, a node is deleted from the data structure at the corresponding location. Unit(s) of the updated document resulting from the insertion or deletion are associated to respective original reference(s) in the data structure. During a conference between an editor and other participant(s), a display is generated and presented to the editor. The display includes the unit(s) of the updated document, current reference(s) to the unit(s), and the original reference(s) associated with the unit(s).

### TECHNICAL FIELD

The present invention relates to managing a display of a document, and more particularly to managing a display of references to document units to facilitate collaborative document review.

### BACKGROUND

In a collaborative generation and editing of a large electronic document, such as a slide presentation or a word processing document, the contents are created in sections by multiple authors. The authors send in the sections they create and the sections are assembled into a master document. A group of people participate in a telephone conference to conduct a review and revision of the master document. The group includes an editor and one or more other participants who are remote from the editor. During the conference, the editor and the one or more other participants each review their own copy of the master document. At the start of the conference, the copies of the master document being reviewed by the editor and other participant(s) are the same, with each copy having the same set of original page numbers. During the conference, the editor inserts and/or deletes pages of the document on the fly, which creates an updated version of the document having a set of updated page numbers. After updating the pages, there is a lack of synchronization between the versions of the document page numbers viewed by the editor and the other participant(s) because the editor views the updated page numbers but not the original page numbers, while the other participant(s) view the original page numbers but not the updated page numbers. As an alternate to the telephone conference, the group may participate in a web conference in which all participants can see an updated page to which the editor refers, without reference to a page number. Some people in the group, however, may not be able to join in a web conference.

### BRIEF SUMMARY

In a first embodiment, the present invention provides a method of managing a display of references to units of a document. The method includes a computer storing the units of an original version of the document and original references to the units of the original version of the document in respective nodes of a data structure. The method further includes the computer determining the document is updated at a location in the document by an insertion of a new unit or a deletion of a unit in the units of the document, resulting in unit(s) of the updated document, and (1) responsive to the insertion, the computer inserting a new node at a location in the data structure matching the location in the document, or (2) responsive to the deletion, the computer deleting a node at the location in the data structure matching the location in the document. The method further includes, subsequent to the step of inserting the new node or deleting the node, the computer associating the unit(s) of the updated document to respective original reference(s) included in the original references stored in the nodes of the data structure. The method further includes, during a conference between a human editor and one or more other participants, the computer generating and presenting to the editor a display including the unit(s) of the updated document, current reference(s) to the unit(s) of the updated document, and the original reference(s) associated with the unit(s) of the updated document.

In a second embodiment, the present invention provides a computer system including a central processing unit (CPU); a memory coupled to the CPU; and a computer-readable storage device coupled to the CPU. The storage device includes instructions that are executed by the CPU via the memory to implement a method of managing a display of references to units of a document. The method includes the computer system storing the units of an original version of the document and original references to the units of the original version of the document in respective nodes of a data structure. The method further includes the computer system determining the document is updated at a location in the document by an insertion of a new unit or a deletion of a unit in the units of the document, resulting in unit(s) of the updated document, and (1) responsive to the insertion, the computer system inserting a new node at a location in the data structure matching the location in the document, or (2) responsive to the deletion, the computer system deleting a node at the location in the data structure matching the location in the document. The method further includes, subsequent to the step of inserting the new node or deleting the node, the computer system associating the unit(s) of the updated document to respective original reference(s) included in the original references stored in the nodes of the data structure. The method further includes, during a conference between a human editor and one or more other participants, the computer system generating and presenting to the editor a display including the unit(s) of the updated document, current reference(s) to the unit(s) of the updated document, and the original reference(s) associated with the unit(s) of the updated document.

In a third embodiment, the present invention provides a computer program product including a computer-readable storage device and a computer-readable program code stored in the computer-readable storage device. The computer-readable program code includes instructions that are executed by a central processing unit (CPU) of a computer system to implement a method of managing a display of references to units of a document. The method includes the computer system storing the units of an original version of the document and original references to the units of the original version of the document in respective nodes of a data structure. The method further includes the computer system determining the document is updated at a location in the document by an insertion of a new unit or a deletion of a unit in the units of the document, resulting in unit(s) of the updated document, and (1) responsive to the insertion, the computer system inserting a new node at a location in the data structure matching the location in the document, or (2) responsive to the deletion, the computer system deleting a node at the location in the data structure matching the location in the document. The method further includes, subsequent to the step of inserting the new node or deleting the node, the computer system associating the unit(s) of the updated document to respective original reference(s) included in the original references stored in the nodes of the data structure. The method further includes, during a conference between a human editor and one or more other participants, the computer system generating and presenting to the editor a display including the unit(s) of the updated document, current reference(s) to the unit(s) of the updated document, and the original reference(s) associated with the unit(s) of the updated document.

Embodiments of the present invention facilitate collaborative review of a document in a telephone conference between an editor who views an updated version of a document having updated page numbers and remote participant(s) who view an original version of the document, but not the updated version. The editor views a display that associates pages of the updated document with original page numbers, thereby allowing the editor to refer to a page having an updated page number which is different from a corresponding original page number by communicating to the remote participant(s) the original page number that corresponds to the updated page number. By allowing the editor to communicate the original page number, the other participant(s) avoid the extra and error-prone manual work of tracking the types of updates done to the document by the editor and the locations in the document where the updates occurred in order to mentally convert each mention of an updated page number by the editor into its corresponding original page number.

### BRIEF DESCRIPTION OF THE DRAWINGS

FIG. 1 is a block diagram of a system for managing a display of references to units of a document, in accordance with embodiments of the present invention.

FIG. 2 is a flowchart of a process of managing a display of references to units of a document, where the process is implemented in the system of FIG. 1, in accordance with embodiments of the present invention.

FIG. 3 depicts an example of a display of page numbers managed by the process of FIG. 2, where the page numbers reference document pages that are updated by an insertion of a new page, in accordance with embodiments of the present invention.

FIG. 4 depicts an example of a display of page numbers managed by the process of FIG. 2, where the page numbers reference document pages that are updated by a deletion of a page, in accordance with embodiments of the present invention.

FIG. 5 depicts an example of a display of a spreadsheet whose column indicators are managed by the process of FIG. 2, where the column indicators reference columns of the spreadsheet that are updated by an insertion of a new column, in accordance with embodiments of the present invention.

FIG. 6 is a block diagram of a computer that is included in the system of FIG. 1 and that implements the process of FIG. 2, in accordance with embodiments of the present invention.

### DETAILED DESCRIPTION

### Overview

Embodiments of the present invention stores original references (e.g., original page numbers) to corresponding units (e.g., pages) of a document in a data structure (e.g., linked list). During a conference in which an editor and one or more other participant(s) are collaboratively reviewing a document, embodiments of the present invention determine an update to the document has been made by the editor via a software application (e.g., word processing application) and updates the data structure so that original references stored in the data structure remain associated with their corresponding units in the updated document. For example, the updated data structure provides a one-to-one correspondence between current page numbers of pages in the updated document and original page numbers that correspond to the pages in the updated document. During the conference, the editor can view each unit in the updated document along with the unit's current reference and the unit's original reference. Because the other participant(s) in the conference do not view the current references, the editor refers to a unit in the updated document by communicating the original reference to the other participant(s) rather than the current reference.

As used herein, a document is defined as electronic media content, which may be a word processing document provided by word processing software, a slide presentation provided by presentation software, or a spreadsheet provided by spreadsheet software. As used herein, a unit of a document is defined as a section of a document that is identifiable by one of a sequence of indicators such as numbers or letters. A unit of a document is a page included in a word processing document, a slide included in a slide presentation, or a cell, row, or column included in a spreadsheet. As used herein, a reference is defined as an indicator in a sequence of indicators that identify units of a document based on the order in which the units are presented to a reader of the document. A reference allows a reader of the document to cite a particular unit of the document. In embodiments of the present invention, a reference is a number, a letter, a combination of numbers, a combination of letters, or a combination of number(s) and letter(s). In one embodiment, a reference is a page number of a page in a word processing document, a slide number of a slide in a presentation, or a row, a column, or a row and column in a spreadsheet.

### System for Managing a Display of References to Units of a Document

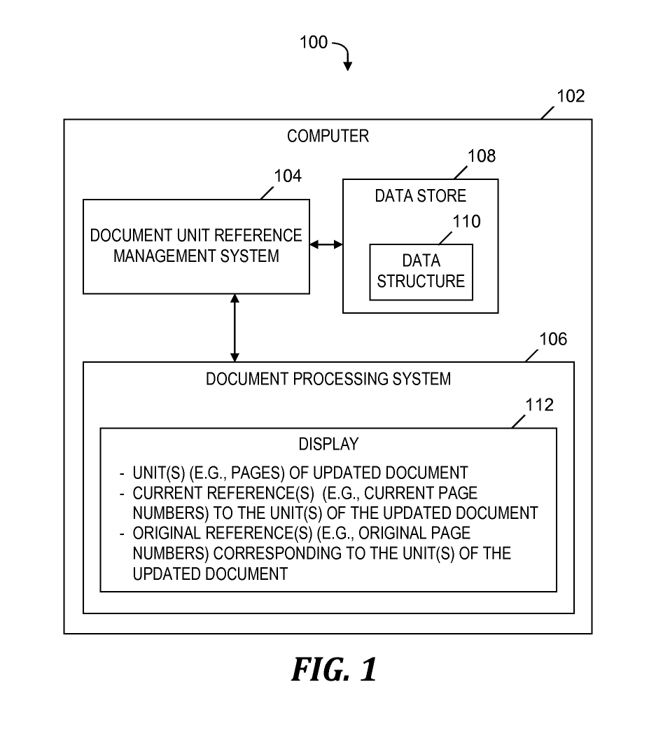

FIG. 1 is a block diagram of a system 100 for managing a display of references to units of a document, in accordance with embodiments of the present invention. System 100 includes a computer 102, which executes a software based document unit reference management system 104 and a software-based document processing system 106. In one embodiment, document processing system 106 is a word processing system, a slide presentation application, or a spreadsheet application. Document unit reference management system 104 is coupled to data store 108, which stores units of an original version of a document and original references to the units in nodes of a data structure 110. The nodes in data structure 110 are initially associated with units of the document in a one-to-one correspondence. In one embodiment, data structure 110 is a linked list.

Document unit reference management system 104 determines the document is updated by an insertion of a new unit or a deletion of one of the units at a location in the document. If the document was updated by an insertion of a new unit at the location, then document unit reference management system 104 inserts a node in a location in data structure 110 that matches the location of the update of the document, so that the updated nodes resulting from the insertion of the node remain associated with the units of the updated document in a one-to one correspondence. If the document was updated by a deletion of a unit at the location in the document, then document unit reference management system 104 deletes a node in a location in data structure 110 that matches the location in the document, so that the updated node(s) resulting from the deletion of the node remain associated with the unit(s) of the updated document in a one-to-one correspondence.

After the updates of the document and data structure 110, document processing system 106 generates a display 112, which includes unit(s) of the updated document, current reference(s) to the unit(s) of the updated document, and original reference(s) corresponding to the unit(s) of the updated document. Document processing system 106 initiates a presentation of display 112 on a display device of a computer being utilized by one participant (i.e., an editor) of multiple participants of a telephone conference or another conference in which the editor makes updates to the document which can be viewed by the editor during the conference, but the other participant(s) cannot view the current reference(s) during the conference. In one embodiment, the other participant(s) do not view display 112. By viewing display 112, the editor views a current reference and an original reference to a unit in the updated document, and subsequently cites the unit by communicating to the other participant(s) the original reference to the cited unit without communicating the current reference of the cited unit.

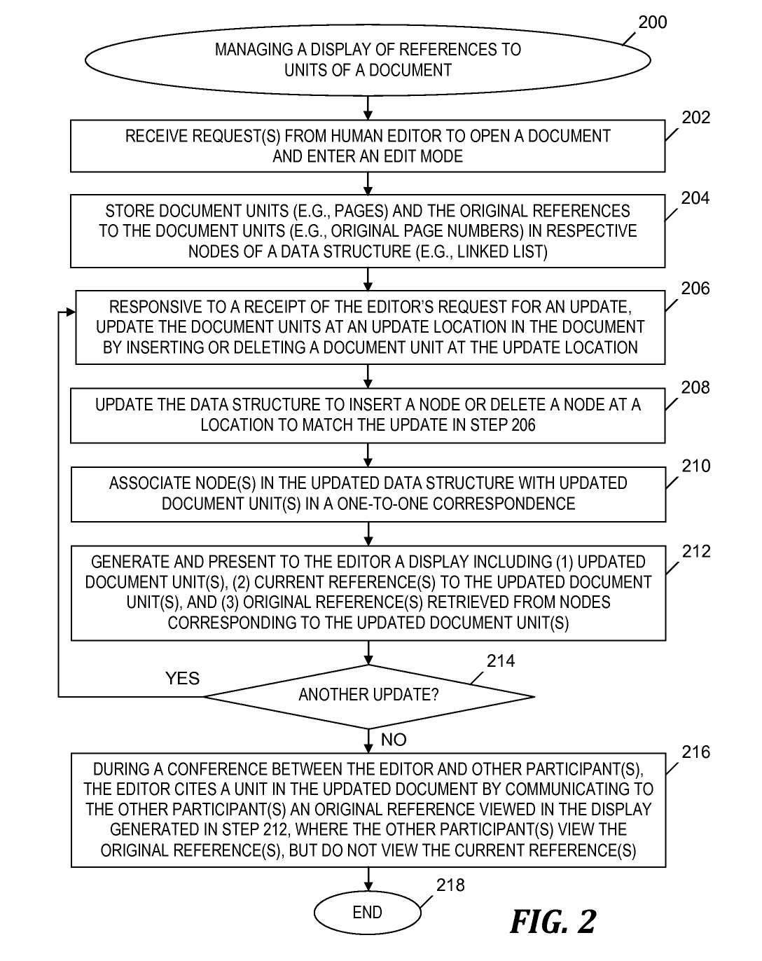

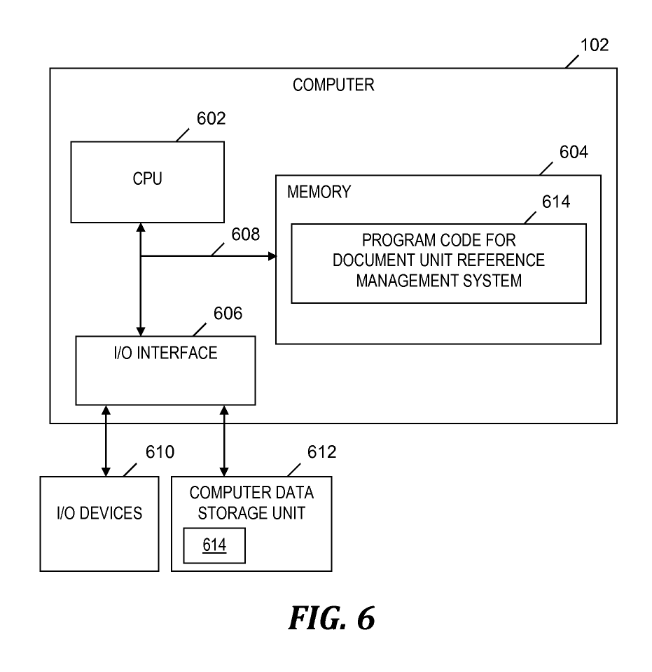

The functionality of the components of FIG. 1 is described in more detail in the discussion presented below relative to FIG. 2 and FIG. 6.

### Process for Managing a Display of References to Units of a Document

FIG. 2 is a flowchart of a process of managing a display of references to units of a document, where the process is implemented in system 100 of FIG. 1, in accordance with embodiments of the present invention. The process of FIG. 2 starts at step 200. In step 202, document unit reference management system 104 (see FIG. 1) receives request(s) from a human editor to open a document and enter an edit mode for the opened document.

In step 204, document unit reference management system 104 (see FIG. 1) stores units of the document and original references to units of the document in respective nodes of data structure 110 (see FIG. 1). For example, document unit reference management system 104 (see FIG. 1) stores pages of an original version of a word processing document and original page numbers of the original version of the word processing document in respective nodes of a linked list.

In an alternate embodiment, step 204 includes document unit reference management system 104 (see FIG. 1) storing original references to units of the original version of the document in respective nodes of data structure 110 (see FIG. 1) and document processing system 106 (see FIG. 1) storing the units of the original version of the document, instead of document unit reference management system 104 (see FIG. 1) storing the units of the original version.

After step 204 and prior to step 206, computer 102 (see FIG. 1) receives request from the editor to update the document at an update location by an insertion of a new unit into the document at the update location or a deletion of a unit from the document, where the unit to be deleted is at the update location. In step 206, responsive to the receipt of the editor's request for the update of the document, document processing system 106 (see FIG. 1) updates the units of the document by inserting a new unit if the request was for an insertion of a new unit into the document, or by deleting a unit at the update location if the request was for a deletion of the unit from the document. The result of the update in step 206 is that the document includes one or more units.

In step 208, document unit reference management system 104 (see FIG. 1) updates data structure 110 (see FIG. 1) to match the update of the document in step 206 (i.e., update by inserting a new node to match an insertion of a new unit in the document, or by deleting a node to match a deletion of a unit in the document). The result of the update in step 208 is that data structure 110 (see FIG. 1) includes one or more nodes. If step 206 included an insertion of a unit at the update location in the document, then step 208 includes document unit reference management system 104 (see FIG. 1) inserting a new node into data structure 110 (see FIG. 1) at a location that matches the update location. For example, if a page is inserted into the document after the third page of the document in step 206, then in step 208 document unit reference management system 104 (see FIG. 1) inserts a new node after the third node in a linked list, which is data structure 110 (see FIG. 1).

If step 206 included a deletion of a unit at the update location in the document, then step 208 includes document unit reference management system 104 (see FIG. 1) deleting a node in data structure 110 (see FIG. 1) at a location that matches the update location. For example, if a fourth page is deleted from the document in step 206, then in step 208 document unit reference management system 104 (see FIG. 1) deletes the fourth node in a linked list, which is data structure 110 (see FIG. 1).

In step 210, document unit reference management system 104 (see FIG. 1) associates the node(s) in the data structure updated in step 208 with the unit(s) remaining in the document after the update in step 206, in one-to-one correspondence.

In step 212, document unit reference management system 104 (see FIG. 1) generates display 112 (see FIG. 1) and presents (i.e., initiates a display of) display 112 (see FIG. 1) to a computer being utilized by the editor. Display 112 (see FIG. 1) includes the one or more of the units of the document updated in step 206, current reference(s) (e.g., current page numbers) to the one or more units of the updated document, and original reference(s) to the one or more units of the updated document. Prior to step 212, document unit reference management system 104 (see FIG. 1) retrieves the original reference(s) to be included in display 112 (see FIG. 1) from data structure 110 (see FIG. 1).

In step 214, document unit reference management system 104 (see FIG. 1) determines whether the editor has requested another update to the document (i.e., determines whether another request from the editor to update the document is received by document unit reference management system 104 (see FIG. 1)). If document unit reference management system 104 (see FIG. 1) determines in step 214 that the editor has requested another update to the document, then the Yes branch of step 214 is taken and the process of FIG. 2 loops back to step 206. If document unit reference management system 104 (see FIG. 1) determines in step 214 that the editor has not requested another update of the document, then the No branch of step 214 is taken and step 216 is performed.

In step 216, during a telephone conference or other conference in which the editor views display 112 (see FIG. 1) and other participant(s) in the conference view the original reference(s) but cannot view the current reference(s) to the unit(s) of the updated document, the editor cites a unit of the updated document by viewing both the current reference to the unit and the original reference to the unit, where the current and original references are different, and subsequently communicating the original reference, but not the current reference, to the other participant(s).

Following step 216, the process of FIG. 2 ends at step 218.

### Examples

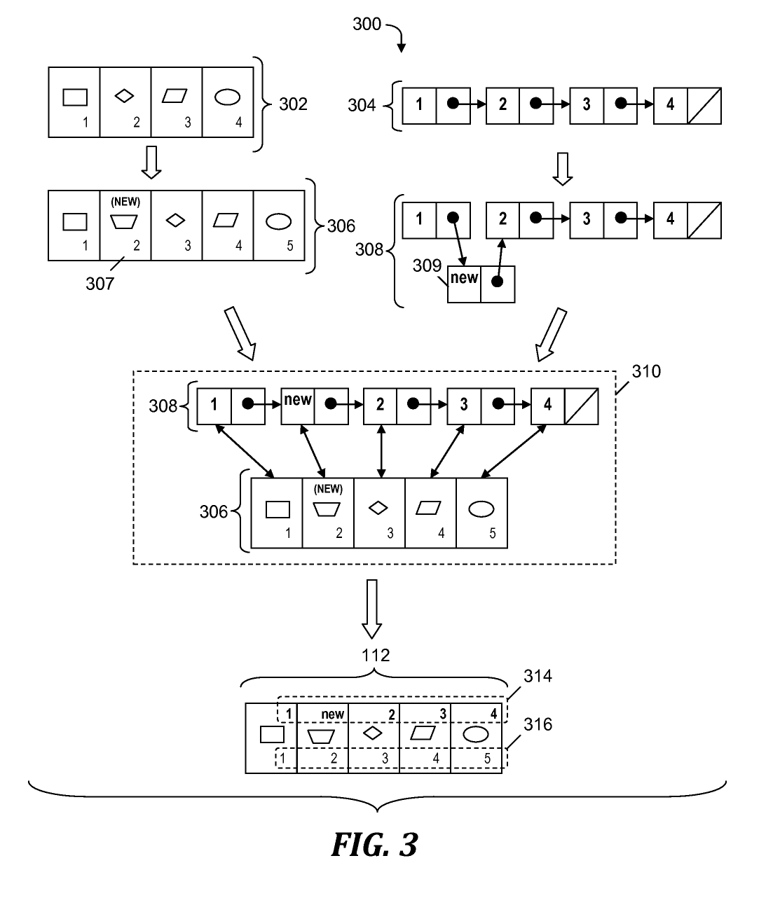

FIG. 3 depicts an example 300 of a display of page numbers managed by the process of FIG. 2, where the page numbers reference document pages that are updated by an insertion of a new page, in accordance with embodiments of the present invention. Example 300 starts with an original version of a document 302, which has four pages numbered 1, 2, 3 and 4. In step 204 (see FIG. 2), the four page numbers of the original version of document 302 are stored in the respective payloads of four nodes in an original version of a linked list 304, which is data structure 110 (see FIG. 1).

In step 206 (see FIG. 2), responsive to an initiation of an update of document 302 by an editor, document 302 is updated to become updated document 306, which is a result of an insertion of a new page 307 between pages 1 and 2 in document 302. Updated document 306 has five pages (i.e., the four original pages plus the newly inserted page), which have updated page numbers (i.e., current page numbers) 1, 2, 3, 4 and 5.

In step 208 (see FIG. 2), original linked list 304 is updated to become an updated linked list 308, which is a result of an insertion of a new node 309 between the first and second nodes (i.e., between the nodes corresponding to pages 1 and 2 in document 302). Updated linked list 308 has five nodes (i.e., the four original nodes plus the newly inserted node).

In step 210 (see FIG. 2), a mapping 310 is generated to associate the five nodes in updated linked list 308 with the five pages in updated document 306 in a one-to-one correspondence. Mapping 310 maintains an association between original page numbers in nodes in the updated linked list 308 and the pages in updated document 306 that had been identified by the original page numbers prior to the insertion of the page. For example, mapping 310 maintains the association of the node whose payload is 2 with the page whose original page number was 2, but whose current page number is 3.

In step 212 (see FIG. 2), document processing system 106 (see FIG. 1) generates and presents display 112 to the editor. Display 112 generated in FIG. 3 includes the content of the five pages of updated document 306, original page numbers included in a set of page numbers 314, and a set of updated page numbers 316 (i.e., the current page numbers of the pages of document 306). Original page numbers included in set 314 are positioned in display 112 to overlap respective pages of updated document 306, thereby indicating the original page numbers of the pages of updated document 306 that had been in the original version of document 302. Set 314 is generated to include an indicator of “new” overlapping page 2 to indicate the newly inserted page.

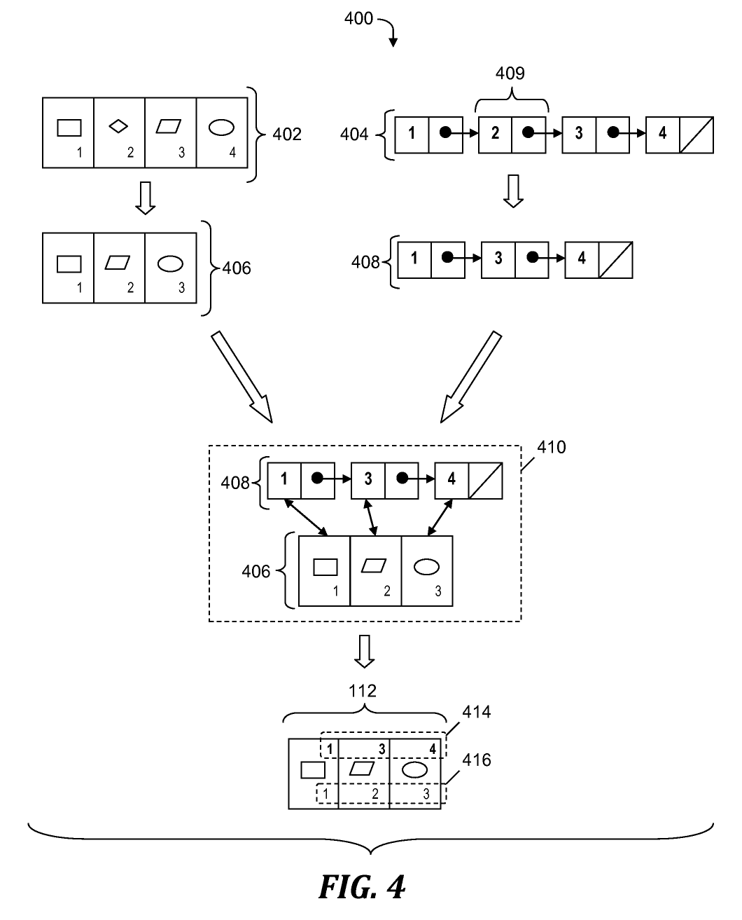

FIG. 4 depicts an example 400 of a display of page numbers managed by the process of FIG. 2, where the page numbers reference document pages that are updated by a deletion of a page, in accordance with embodiments of the present invention. Example 400 starts with an original version of a document 402, which has four pages numbered 1, 2, 3 and 4. In step 204 (see FIG. 2), the four page numbers of the original version of document 402 are stored in the respective payloads of four nodes in an original version of a linked list 404, which is data structure 110 (see FIG. 1).

In step 206 (see FIG. 2), responsive to an initiation of an update of document 402 by an editor, document 402 is updated to become updated document 406, which is a result of a deletion of the second page in document 402. Updated document 406 has three pages (i.e., the four original pages plus the newly inserted page), which have updated page numbers (i.e., current page numbers) 1, 2, and 3.

In step 208 (see FIG. 2), original linked list 404 is updated to become an updated linked list 408, which is a result of a deletion of a node 409 (i.e., the second node in original linked list 404). Updated linked list 408 has three nodes, which had been the first, third and fourth nodes in original linked list 404.

In step 210 (see FIG. 2), a mapping 410 is generated to associate the three nodes in updated linked list 408 with the three pages in updated document 406 in a one-to-one correspondence. Mapping 410 maintains an association between original page numbers in nodes in the updated linked list 408 and the pages in updated document 406 that had been identified by the original page numbers prior to the deletion of the second page. For example, mapping 410 maintains the association of the node whose payload is 3 with the page whose original page number was 3, but whose current page number is 2.

In step 212 (see FIG. 2), document processing system 106 (see FIG. 1) generates and presents display 112 to the editor. Display 112 generated in FIG. 4 includes the content of the three pages of updated document 406, original page numbers included in a set of page numbers 414, and a set of updated page numbers 416 (i.e., the current page numbers of the pages of updated document 406). Original page numbers included in set 414 are positioned in display 112 to overlap respective pages of updated document 406, thereby indicating the original page numbers of the pages of updated document 406.

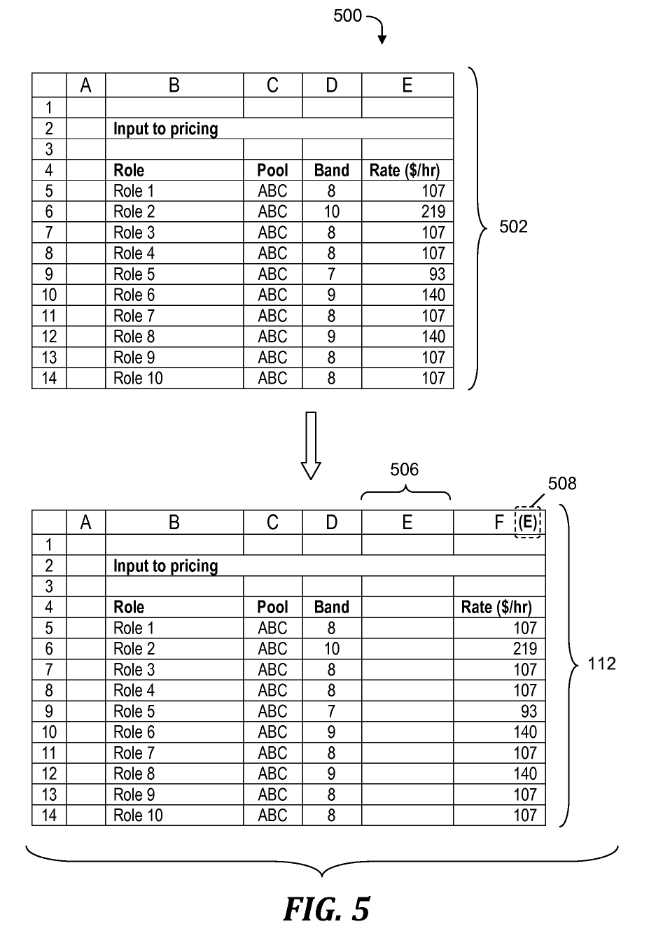

FIG. 5 depicts an example 500 of a display of a spreadsheet whose column indicators are managed by the process of FIG. 2, where the column indicators reference columns of the spreadsheet that are updated by an insertion of a new column, in accordance with embodiments of the present invention. Example 500 starts with an original version of a spreadsheet 502, which has five columns having respective indicators A, B, C, D and E. The original column indicators A, B, C, D and E are stored in respective nodes in a linked list (not shown) in step 204. After an insertion of a new column after column D in step 206 (resulting in updated columns A, B, C, D, E and F in an updated spreadsheet) and an insertion in step 208 of a new node into the linked list where the newly inserted node corresponds to the newly inserted column (resulting in six updated nodes having respective payloads A, B, C, D, “new,” and E), the nodes in the updated linked list are associated in step 210 with the columns A, B, C, D, E and F in a one-to-one correspondence.

In step 212 (see FIG. 2), document processing system 106 (see FIG. 1) generates and presents display 112 to the editor. Display 112 generated in FIG. 5 includes the content of the updated spreadsheet, which includes a newly inserted column 506 (i.e., column E in the updated columns), original column indicator 508 (i.e., original column E), and the indicators A, B, C, D, E and F of the updated columns. Original column indicator 508 is positioned in display 112 to overlap the respective header of column F in the updated spreadsheet, thereby indicating that column F in the updated spreadsheet was column E in the original version of the spreadsheet 502.

### Computer System

FIG. 6 is a block diagram of a computer that is included in the system of FIG. 1 and that implements the process of FIG. 2, in accordance with embodiments of the present invention. Computer 102 is a computer system or mobile computing device that generally includes a central processing unit (CPU) 602, a memory 604, an input/output (I/O) interface 606, and a bus 608. Further, computer 102 is coupled to I/O devices 610 and a computer data storage unit 612. CPU 602 performs computation and control functions of computer 102, including carrying out instructions included in program code 614 to perform a method of managing a display of references to units of a document, where the instructions are carried out by CPU 602 via memory 604. CPU 602 may include a single processing unit, or be distributed across one or more processing units in one or more locations (e.g., on a client and server). Program code 614 includes program code for document unit reference management system 104 (see FIG. 1) and document processing system 106 (see FIG. 1).

Memory 604 includes a known computer readable storage medium, which is described below. In one embodiment, cache memory elements of memory 604 provide temporary storage of at least some program code (e.g., program code 614) in order to reduce the number of times code must be retrieved from bulk storage while instructions of the program code are carried out. Moreover, similar to CPU 602, memory 604 may reside at a single physical location, including one or more types of data storage, or be distributed across a plurality of physical systems in various forms. Further, memory 604 can include data distributed across, for example, a local area network (LAN) or a wide area network (WAN).

I/O interface 606 includes any system for exchanging information to or from an external source. I/O devices 610 include any known type of external device, including a display device, keyboard, etc. Bus 608 provides a communication link between each of the components in computer 102, and may include any type of transmission link, including electrical, optical, wireless, etc.

I/O interface 606 also allows computer 102 to store information (e.g., data or program instructions such as program code 614) on and retrieve the information from computer data storage unit 612 or another computer data storage unit (not shown). Computer data storage unit 612 includes a known computer-readable storage medium, which is described below. In one embodiment, computer data storage unit 612 is a non-volatile data storage device, such as a magnetic disk drive (i.e., hard disk drive) or an optical disc drive (e.g., a CD-ROM drive which receives a CD-ROM disk).

Memory 604 and/or storage unit 612 may store computer program code 614 that includes instructions that are carried out by CPU 602 via memory 604 to manage a display of references to units of a document. Although FIG. 6 depicts memory 604 as including program code 614, the present invention contemplates embodiments in which memory 604 does not include all of code 614 simultaneously, but instead at one time includes only a portion of code 614. Further, memory 604 includes an operating system (not shown) and may include other systems not shown in FIG. 6.

Storage unit 612 and/or one or more other computer data storage units (not shown) that are coupled to computer 102 may include data store 108 (see FIG. 1).

As will be appreciated by one skilled in the art, in a first embodiment, the present invention may be a system; in a second embodiment, the present invention may be a method; and in a third embodiment, the present invention may be a computer program product.

Any of the components of an embodiment of the present invention can be deployed, managed, serviced, etc. by a service provider that offers to deploy or integrate computing infrastructure with respect to managing a display of references to units of a document. Thus, an embodiment of the present invention discloses a process for supporting computer infrastructure, where the process includes providing at least one support service for at least one of integrating, hosting, maintaining and deploying computer-readable code (e.g., program code 614) in a computer system (e.g., computer 102) including one or more processors (e.g., CPU 602), wherein the processor(s) carry out instructions contained in the code causing the computer system to manage a display of references to units of a document. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of managing a display of references to units of a document.

While it is understood that program code 614 for managing a display of references to units of a document may be deployed by manually loading directly in client, server and proxy computers (not shown) via loading a computer-readable storage medium (e.g., computer data storage unit 612), program code 614 may also be automatically or semi-automatically deployed into computer 102 by sending program code 614 to a central server or a group of central servers. Program code 614 is then downloaded into client computers (e.g., computer 102) that will execute program code 614. Alternatively, program code 614 is sent directly to the client computer via e-mail. Program code 614 is then either detached to a directory on the client computer or loaded into a directory on the client computer by a button on the e-mail that executes a program that detaches program code 614 into a directory. Another alternative is to send program code 614 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 614 is transmitted to the proxy server and then it is stored on the proxy server.

Another embodiment of the invention provides a method that performs the process steps on a subscription, advertising and/or fee basis. That is, a service provider, such as a Solution Integrator, can offer to create, maintain, support, etc. a process of managing a display of references to units of a document. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product. The computer program product may include a computer readable storage medium (or media) (memory 604 and computer data storage unit 612) having computer readable program instructions 614 thereon for causing a processor (e.g., CPU 602) to carry out aspects of the present invention.

The computer readable storage medium can be a tangible device that can retain and store instructions (e.g., program code 614) for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 614) described herein can be downloaded to respective computing/processing devices (e.g., computer 102) from a computer readable storage medium or to an external computer or external storage device (e.g., computer data storage unit 612) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 614) for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 6) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 614).

These computer readable program instructions may be provided to a processor (e.g., CPU 602) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 612) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 614) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of managing a display of references to units of a document, the method comprising the steps of:
a computer storing the units of an original version of the document and original references to the units of the original version of the document in respective nodes of a data structure;
the computer determining the document is updated at a location in the document by an insertion of a new unit or a deletion of a unit in the units of the document, resulting in unit(s) of the updated document, and (1) responsive to the insertion, the computer inserting a new node at a location in the data structure matching the location in the document, or (2) responsive to the deletion, the computer deleting a node at the location in the data structure matching the location in the document;
subsequent to the step of inserting the new node or deleting the node, the computer associating the unit(s) of the updated document to respective original reference(s) included in the original references stored in the nodes of the data structure; and
during a conference between a human editor and one or more other participants, the computer generating and presenting to the editor a display including the unit(s) of the updated document, current reference(s) to the unit(s) of the updated document, and the original reference(s) associated with the unit(s) of the updated document.

2. The method of claim 1, wherein the step of presenting the display to the editor includes presenting the display without a presentation of the current reference(s) to the one or more other participants, and without a concurrent or subsequent presentation of the original version of the document to the editor.

3. The method of claim 1, further comprising, based on the display presented to the editor, providing to the editor an original reference to identify to the one or more participants a unit included in the unit(s) of the updated document, the original reference being included in the original reference(s), the original reference being viewed by the one or more other participants during the conference, and the original reference being associated with the unit included in the unit(s) in response to the step of associating.

4. The method of claim 1, wherein the document is a word processing document and the units are pages in the word processing document, wherein the step of storing the units includes storing the pages and original page numbers of the pages in the data structure, wherein the step of determining the document is updated includes determining the word processing document is updated at the location by an insertion of a new page or a deletion of a page in the pages in the word processing document, which results in the unit(s) which are page(s) of the word processing document, wherein the step of associating the unit(s) includes associating the page(s) to respective original page number(s) included in the original page numbers, and wherein the step of generating the display includes generating the display so that the display includes the page(s) of the word processing document, current page number(s) of the page(s), and the original page number(s) associated with the page(s).

5. The method of claim 1, wherein the document is a slide presentation provided by a computer application and the units are slides in the slide presentation, wherein the step of storing the units includes storing the slides and original slide numbers of the slides in the data structure, wherein the step of determining the document is updated includes determining the slide presentation is updated at the location by an insertion of a new slide or a deletion of a slide in the slides in the slide presentation, which results in the unit(s) which are slide(s) of the slide presentation, wherein the step of associating the unit(s) includes associating the slide(s) to respective original slide number(s) included in the original slide numbers, and wherein the step of generating the display includes generating the display so that the display includes the slide(s) of the slide presentation, current slide number(s) of the slide(s), and the original slide number(s) associated with the slide(s).

6. The method of claim 1, wherein the document is a spreadsheet provided by a computer application and the units are cells in the spreadsheet, wherein the step of storing the units includes storing the cells and original row and column numbers of the cells in the data structure, wherein the step of determining the document is updated includes determining the spreadsheet is updated at the location by an insertion of a new cell or a deletion of a cell in the cells in the spreadsheet, which results in the unit(s) which are cell(s) of the spreadsheet, wherein the step of associating the unit(s) includes associating the cell(s) to respective original row and column number(s) included in the original row and column numbers, and wherein the step of generating the display includes generating the display so that the display includes the cell(s) of the spreadsheet, current row and column number(s) of the cell(s), and the original row and column number(s) associated with the cell(s).

7. The method of claim 1, further comprising the steps of:
the computer receiving a request from the editor to open the document in an edit mode; and
the computer receiving from the editor an entry of the insertion of the new unit or the deletion of the unit;
wherein the step of storing the units is performed in response to the step of receiving the request to open the document in the edit mode, and
wherein the step of determining the document is updated is performed in response to the step of receiving from the editor the entry of the insertion or the deletion.

8. The method of claim 1, further comprising:
providing at least one support service for at least one of creating, integrating, hosting, maintaining, and deploying computer-readable program code in the computer, the program code being executed by a processor of the computer to implement the steps of storing, determining, inserting responsive to the insertion or deleting responsive to the deletion, associating, and generating and presenting.

9. A computer system comprising:
a central processing unit (CPU);
a memory coupled to the CPU; and
a computer-readable storage device coupled to the CPU, the storage device containing instructions that are executed by the CPU via the memory to implement a method of managing a display of references to units of a document, the method comprising the steps of:
the computer system storing the units of an original version of the document and original references to the units of the original version of the document in respective nodes of a data structure;
the computer system determining the document is updated at a location in the document by an insertion of a new unit or a deletion of a unit in the units of the document, resulting in unit(s) of the updated document, and (1) responsive to the insertion, the computer system inserting a new node at a location in the data structure matching the location in the document, or (2) responsive to the deletion, the computer system deleting a node at the location in the data structure matching the location in the document;
subsequent to the step of inserting the new node or deleting the node, the computer system associating the unit(s) of the updated document to respective original reference(s) included in the original references stored in the nodes of the data structure; and
during a conference between a human editor and one or more other participants, the computer system generating and presenting to the editor a display including the unit(s) of the updated document, current reference(s) to the unit(s) of the updated document, and the original reference(s) associated with the unit(s) of the updated document.

10. The computer system of claim 9, wherein the step of presenting the display to the editor includes presenting the display without a presentation of the current reference(s) to the one or more other participants, and without a concurrent or subsequent presentation of the original version of the document to the editor.

11. The computer system of claim 9, wherein the method further comprises, based on the display presented to the editor, providing to the editor an original reference to identify to the one or more participants a unit included in the unit(s) of the updated document, the original reference being included in the original reference(s), the original reference being viewed by the one or more other participants during the conference, and the original reference being associated with the unit included in the unit(s) in response to the step of associating.

12. The computer system of claim 9, wherein the document is a word processing document and the units are pages in the word processing document, wherein the step of storing the units includes storing the pages and original page numbers of the pages in the data structure, wherein the step of determining the document is updated includes determining the word processing document is updated at the location by an insertion of a new page or a deletion of a page in the pages in the word processing document, which results in the unit(s) which are page(s) of the word processing document, wherein the step of associating the unit(s) includes associating the page(s) to respective original page number(s) included in the original page numbers, and wherein the step of generating the display includes generating the display so that the display includes the page(s) of the word processing document, current page number(s) of the page(s), and the original page number(s) associated with the page(s).

13. The computer system of claim 9, wherein the document is a slide presentation provided by a computer system application and the units are slides in the slide presentation, wherein the step of storing the units includes storing the slides and original slide numbers of the slides in the data structure, wherein the step of determining the document is updated includes determining the slide presentation is updated at the location by an insertion of a new slide or a deletion of a slide in the slides in the slide presentation, which results in the unit(s) which are slide(s) of the slide presentation, wherein the step of associating the unit(s) includes associating the slide(s) to respective original slide number(s) included in the original slide numbers, and wherein the step of generating the display includes generating the display so that the display includes the slide(s) of the slide presentation, current slide number(s) of the slide(s), and the original slide number(s) associated with the slide(s).

14. The computer system of claim 9, wherein the document is a spreadsheet provided by a computer system application and the units are cells in the spreadsheet, wherein the step of storing the units includes storing the cells and original row and column numbers of the cells in the data structure, wherein the step of determining the document is updated includes determining the spreadsheet is updated at the location by an insertion of a new cell or a deletion of a cell in the cells in the spreadsheet, which results in the unit(s) which are cell(s) of the spreadsheet, wherein the step of associating the unit(s) includes associating the cell(s) to respective original row and column number(s) included in the original row and column numbers, and wherein the step of generating the display includes generating the display so that the display includes the cell(s) of the spreadsheet, current row and column number(s) of the cell(s), and the original row and column number(s) associated with the cell(s).

15. A computer program product, comprising:
a computer-readable storage device; and
a computer-readable program code stored in the computer-readable storage device, the computer-readable program code containing instructions that are executed by a central processing unit (CPU) of a computer system to implement a method of managing a display of references to units of a document, the method comprising the steps of:
the computer system storing the units of an original version of the document and original references to the units of the original version of the document in respective nodes of a data structure;
the computer system determining the document is updated at a location in the document by an insertion of a new unit or a deletion of a unit in the units of the document, resulting in unit(s) of the updated document, and (1) responsive to the insertion, the computer system inserting a new node at a location in the data structure matching the location in the document, or (2) responsive to the deletion, the computer system deleting a node at the location in the data structure matching the location in the document;
subsequent to the step of inserting the new node or deleting the node, the computer system associating the unit(s) of the updated document to respective original reference(s) included in the original references stored in the nodes of the data structure; and
during a conference between a human editor and one or more other participants, the computer system generating and presenting to the editor a display including the unit(s) of the updated document, current reference(s) to the unit(s) of the updated document, and the original reference(s) associated with the unit(s) of the updated document.

16. The computer program product of claim 15, wherein the step of presenting the display to the editor includes presenting the display without a presentation of the current reference(s) to the one or more other participants, and without a concurrent or subsequent presentation of the original version of the document to the editor.

17. The computer program product of claim 15, wherein the method further comprises, based on the display presented to the editor, providing to the editor an original reference to identify to the one or more participants a unit included in the unit(s) of the updated document, the original reference being included in the original reference(s), the original reference being viewed by the one or more other participants during the conference, and the original reference being associated with the unit included in the unit(s) in response to the step of associating.

18. The computer program product of claim 15, wherein the document is a word processing document and the units are pages in the word processing document, wherein the step of storing the units includes storing the pages and original page numbers of the pages in the data structure, wherein the step of determining the document is updated includes determining the word processing document is updated at the location by an insertion of a new page or a deletion of a page in the pages in the word processing document, which results in the unit(s) which are page(s) of the word processing document, wherein the step of associating the unit(s) includes associating the page(s) to respective original page number(s) included in the original page numbers, and wherein the step of generating the display includes generating the display so that the display includes the page(s) of the word processing document, current page number(s) of the page(s), and the original page number(s) associated with the page(s).

19. The computer program product of claim 15, wherein the document is a slide presentation provided by a computer system application and the units are slides in the slide presentation, wherein the step of storing the units includes storing the slides and original slide numbers of the slides in the data structure, wherein the step of determining the document is updated includes determining the slide presentation is updated at the location by an insertion of a new slide or a deletion of a slide in the slides in the slide presentation, which results in the unit(s) which are slide(s) of the slide presentation, wherein the step of associating the unit(s) includes associating the slide(s) to respective original slide number(s) included in the original slide numbers, and wherein the step of generating the display includes generating the display so that the display includes the slide(s) of the slide presentation, current slide number(s) of the slide(s), and the original slide number(s) associated with the slide(s).

20. The computer program product of claim 15, wherein the document is a spreadsheet provided by a computer system application and the units are cells in the spreadsheet, wherein the step of storing the units includes storing the cells and original row and column numbers of the cells in the data structure, wherein the step of determining the document is updated includes determining the spreadsheet is updated at the location by an insertion of a new cell or a deletion of a cell in the cells in the spreadsheet, which results in the unit(s) which are cell(s) of the spreadsheet, wherein the step of associating the unit(s) includes associating the cell(s) to respective original row and column number(s) included in the original row and column numbers, and wherein the step of generating the display includes generating the display so that the display includes the cell(s) of the spreadsheet, current row and column number(s) of the cell(s), and the original row and column number(s) associated with the cell(s).
